(19) United States
(12) Patent Application Publication
(10) Pub. No.: US 2016/0199938 A1
(43) Pub. Date: Jul. 14, 2016

(54) Method for manufacturing steel sheets for flexible dies

(71) Applicant: Wink Stanzwerkzeuge GmbH & Co. KG, Neuenhaus (DE)

(72) Inventor: Albertus de Natris, Nordhorn (DE)

(21) Appl. No.: 14/757,806

(22) Filed: Dec. 23, 2015

(30) Foreign Application Priority Data
Dec. 23, 2014 (DE) 10 2014 119 581.7

(51) Int. Cl. B23K 26/26; B26D 1/00; B23K 26/0622; B23K 35/02; B23K 26/32; B23K 26/02

(52) U.S. Cl. CPC B23K 26/26; B23K 26/32; B23K 26/02; B23K 26/0622; B23K 35/0261; B26D 1/0006; B23K 2203/04

(57) ABSTRACT

In a method for manufacturing steel sheets for flexible dies with a width of at least 70 cm and a length of at least 30 cm, at least two starting sheets are positioned adjacent to each other and spaced apart by a gap and a welding wire is arranged in contact with both starting sheets at the gap. The two starting sheets are welded to each other by the welding wire and a welding device arranged above the starting sheets and then turned over. An additional welding wire is placed in longitudinal direction of the gap at least partially within the gap in contact with both starting sheets and the starting sheets are welded to each other by means of the additional welding wire. At alignment least one of the welding beads is then brought into alignment with neighboring surfaces of the steel sheet.

The present invention concerns a method for manufacturing steel sheets for flexible dies.

For flexible dies, usually alloyed steel sheets are utilized that must be flexible enough in order to be placed and secured on the cylinders of frequently employed rotary die cutters. On the other hand, flexible dies, for example, for die cutting labels, must be sufficiently hard so that the die lasts for a long time. As flexible die materials of a suitable quality, for example, C60 steels are employed that are purchased as coil material in a typical width of, for example, 60 cm or are cut to length from the coil directly by the steel manufacturers and delivered to the flexible die manufacturer. Greater widths of strip steel for flexible dies have become more and more rare. At this time, there is no manufacturer who for the next two years can offer strip steels in the quality desired for flexible dies and in a width of more than one meter, in particular of 1.20 m, in the required quality.

It is the object of the present invention to provide a method for manufacturing steel sheets of a suitable quality that can be expediently utilized for flexible dies in which the steel sheets comprise a width of at least 70 cm, preferably of at least 1.00 m, and particularly preferred of 1.20 m.

The object is solved by the subject matter according to claim 1 as well as by the subject matter of claim 14. Advantageous embodiments of the object can be taken from the claims depending from these claims as well as the following figure description.

According to the invention, it is provided that for manufacturing a steel sheet of a sufficient quality for flexible dies at least two starting sheets of the required quality, spaced apart form each other by a gap, are positioned adjacent to each other. The starting sheets are preferably positioned on a worktable in this context. The starting sheets can be, for example, held by a magnetic table or by a vacuum system of the worktable.

A welding wire is positioned at the gap advantageously in longitudinal direction of the gap and preferably at least partially within the gap and in particular in contact with at least one of the starting sheets, preferably both of them. Alternatively, the welding wire is positioned by means of an automatic feed device (in the following also referred to as wire feed) on the location that is to be welded and fed as needed, wherein the wire can also be arranged at least partially in contact with the starting sheets and at least partially within the gap. Positioning is realized in such a way that the welding wire by means of the welding device can be melted such that it or the resulting melt, in contact with both starting sheets, can form a connection with them.

The spacing of the starting sheets is realized against the background of avoiding a disadvantageous influence on the weld seam happening during welding or also thereafter by deformations, i.e, changes of the dimensions of the starting sheets. Possibly occurring changes of the dimensions of the starting sheets as a result of expansions are compensated.

According to the invention, the two starting sheets are welded by means of the welding wire and a welding device which is arranged in particular above a first top side of the starting sheets. Subsequently, the starting sheets that are now connected with each other are advantageously turned over so that the bottom sides of the starting sheets, which prior to this are facing a worktable, are now positioned on top. At least one additional welding wire will be or is arranged in the longitudinal direction of the gap or fed by automatic wire feed. Preferably, this at least one additional welding wire is positioned also again at least partially within the gap as well as in particular in contact with both starting sheets. By means of this additional at least one welding wire, the starting sheets are also welded to each other.

Moreover, the weld seam or at least one of the welding beads of the now generated steel sheet is brought into alignment with neighboring surfaces such that the steel sheet exhibits afterwards a uniform thickness. Preferably, both welding beads generated on the sides of the starting sheets or the steel sheet that are facing away from each other are brought into alignment. By means of such a steel sheet it was possible to produce flexible dies that, regardless of the difficulties of connecting, for example, C60 sheets, fulfilled the aforementioned requirements in regard to service life, on the one hand, and in regard to flexibility, on the other hand. In particular in case of flexible dies of an initial thickness of maximally 1.5 mm prior to processing and producing the die cutting lines that could not be connected permanently with conventional welding methods in case of C45, C60, and C75 steels, the use of at least two welding beads for forming a weld seam has lead to the desired result. In this context, the hardness (Shore hardness C) of the weld seam is in particular within a desired range below 55 (45-50).

Advantageously, bringing into alignment the at least one welding bead with the surface is realized immediately after welding such that the welding bead(s) exhibit a temperature above the ambient temperature. Accordingly, expediently a first welding bead is brought into alignment prior to turning over the starting sheets connected to each other and a second welding bead is brought into alignment after turning over the sheets that are connected with each other, i.e., in particular milled to be plane or ground to be plane. Alternatively, the weld seam can first be cooled prior to being brought into alignment with the surface.

Advantageously, the welding device that is designed in particular as a laser welding device comprises at the same time also a milling or welding head with which then by means of the same drive (relative movement of the welding head relative to the starting sheets) welding is performed and also the material strength is adjusted.

The weld seam therefore results from the formation and processing of at least two welding beads wherein the latter can be generated subsequently or simultaneously with or without turning over and from both sides or only one side of the starting sheets. Welding beads therefore mean, independent of their shape with or without raised portion, the connecting areas that result from welding of a single wire with the starting sheets while the ultimately completed total connecting area of the finished steel sheet is defined as a weld seam.

In order to counteract a change of the gap size by the welding process, which could lead to irregularities of the weld seam, the starting sheets can be connected to each other by means of the welding device of the welding wire beforehand by a plurality of spaced-apart welding locations. The welding locations which are spaced apart, for example, by approximately 1 cm-3 cm, can be formed as spot welds but also as rather elongate weld seams or welding beads of minimal lengths of, for example, 0.2 cm.

For producing the welding beads and/or for prior connection of the starting sheets with the goal of positional fixation, the welding wire can also be fed automatically, as is usual otherwise.

A higher quality of the connecting seam is achieved when after the production of each welding bead, with the exception of the final last welding bead, its welding bead surface located within the gap is pre-treated which in particular can lead to a more uniform surface area. Preferably, the welding bead surface is heated, in particular by means of the welding device as such, so that an improved connection between the starting sheets can be provided within the gap, preferably approximately at half the height of the steel sheet to be produced, by partial melting of the welding bead and, if need be, of the starting sheets.

According to the invention, the welding device is in particular designed as a laser welding device and comprises thus a laser that is operated in particular by pulsed operation. This laser can serve for producing the welding beads as well as for pre-treatment of the welding bead surface within the gap. The welding bead can be produced by means of a pulsed laser beam that preferably is operated at a frequency between 1 Hz and 20 Hz, in particular between 3 Hz and 7 Hz. The pulse frequency can be adjusted as a function of the relative speed of the welding head or laser head relative to the starting sheets and governed or controlled as a function of the relative movement. The goal is to produce a uniform welding bead and, in the end, a weld seam where a plurality of welding points are placed adjacent to each other so that the energy introduction at a location of the welding wire is adjusted and the laser beam at this location does not introduce too much energy.

The feed speed is between 0.1 and 6 mm/s, preferably between 0.5 to 2 mm/s.

In particular, the laser beam, in the area in which it is impacting on one of the welding wires, has a diameter that is maximally 0.5 mm smaller than the width of the welding wire. For example, the laser beam, in the area in which it is impacting on the welding wire, can have a relatively minimal width of about 0.1 mm wherein the welding wire has a diameter of 0.5 mm and the gap has an average width, considered across the length, of 0.3 mm. Since initially there is a gap below the welding wire, the energy of the beam should be matched to the thickness of the welding wire and its material.

Preferably, the laser beam, in the area in which it is impacting on one of the welding wires, has a diameter that is greater than the width of the welding wire wherein the welding wire can have a diameter of 0.5 mm and the gap then has an average width, considered across the length, of 0.3 mm. The laser focus has in this context in particular a diameter in the range of 0.5 mm to 1.2 mm. In this context, the laser beam melts the material of the welding wire as well as the material of the edges of the two steel sheets adjoining the gap so that after cooling a strong connection between the welding wire and the two steel sheets results.

Preferably, the diameter of at least one of the welding wires in general is somewhat greater than the width of the gap and in particular is not greater by more than 1 mm, preferably not greater by more than 0.3 mm. On the one hand, this simplifies the positioning of the welding wire because the latter with its often round cross-section does not fall into the gap; on the other hand, for usual flexible die thicknesses, this results from the calculation of the volume required for the weld seam. Finally, in this way, the system is well balanced with regard to the laser beam width in the impact area, the energy transmission to the wire and to the adjoining starting sheets.

In this context, the pulse energy of an individual laser pulse is in a range between 0.5 and 40 Joule, preferably in a range between 5 and 15 Joule. This range covers the energy that is desired for an optimal welding result in connection with the employed materials, speeds, and frequencies.

The gap between the starting sheets has a width of not more than 2 mm, preferably the width is below 0.5 mm wherein this is an average width considered averaged across the length of the gap in the longitudinal direction. By the method according to the invention, weld seams of this width can be produced with reliable processing.

An even higher processing reliability is achieved when the gap is located above a cooling channel of a worktable and in this way the temperature in the area of the welding bead can be controlled better.

Advantageously, for formation of a continuous weld seam in case of the employed materials (C45-C75 steels, in particular C60 steel), welding points are formed by the pulsed laser beam and have centers that are spaced apart from each other by approximately 0.5 mm+−0.2 mm and that pass into each other. This applies to all welding beads that are produced by means of the welding wire and can also apply to the after-treatment of the welding bead surface of the welding beads within the gap.

Advantageously, for fixation and cooling of the starting sheets, the latter are secured by means of a holding device. In this context, the starting sheets can be secured relative to each other and/or relative to a worktable. The holding device comprises for this purpose in particular cover sheets that are made from aluminum, copper or another material with good heat-conducting properties that cover the starting sheets close to the gap, i.e., at a spacing of, for example, maximally 1 cm, and that are secured, in particular by bracing or clamping, together with the starting sheets on a worktable, for example.

An alternative advantageous fixation of the starting sheets is realized by a magnetic table. In addition to the starting sheets, the welding wire placed onto the gap is secured also due to the magnetic fields. In particular in the edge areas of the magnets an additional fixation of the welding wire by means of a holding-down element directly upstream of the welding location in the welding direction may be advantageous.

The aforementioned object is also solved by a flexible die of a width of at least 70 cm and a length of at least 30 cm which is formed from at least two starting sheets of steel, in particular of C60 steel, which are welded to each other. Preferably, this concerns a flexible die which has a flexibility that is sufficient for use on rotary die cutting cylinders.

In particular, a flexible die is produced by a method as afore described and/or described in the following and, subsequently, is in particular etched and/or engraved for forming the die cutting lines.

Alternatively, a flexible die of a width of at least 70 cm and a length of at least 30 cm can be produced immediately by welding at least two steel sheets on which die cutting lines have been formed already, in particular by etching and/or engraving, by a method as afore described and/or described in the following. The sequence of method steps corresponds to the method of the invention, with the exception of the fact that, instead of the steel sheets without die cutting lines, already exposed, etched and/or engraved steel sheets are used.

The minimal distortion resulting from employing the welding process and the minimal after-processing expenditure going hand in hand therewith enable processing of steel sheets provided with die cutting lines. The steel sheets can therefore be provided with die cutting lines on smaller devices for etching or engraving, and thus more flexibly, before the pre-manufactured sheets are joined to the finished flexible die.

Further advantages and details of the invention can be taken from the following figure description.

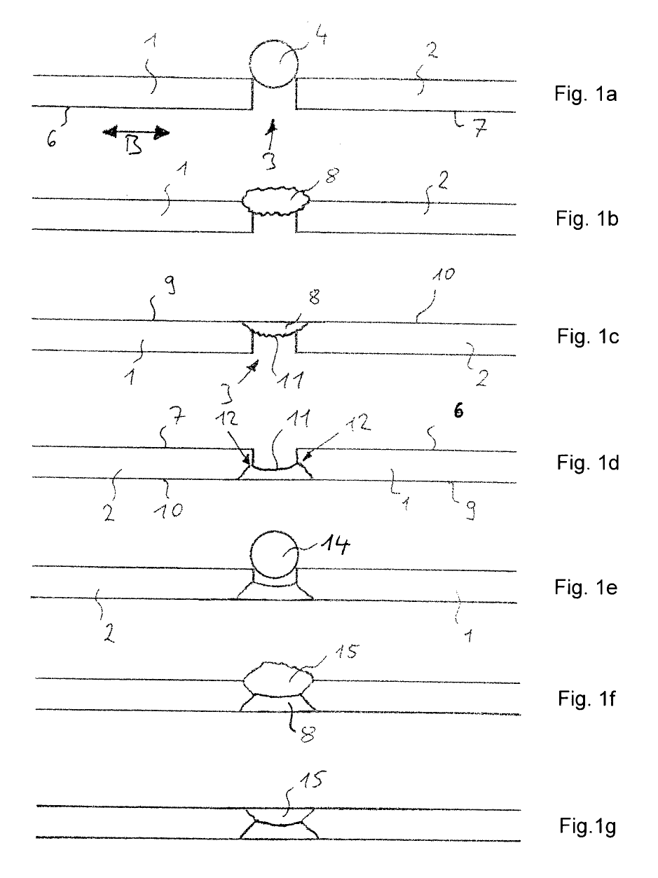

In FIGS. 1 a)-1 g) the individual states during performing of the manufacturing process are illustrated schematically.

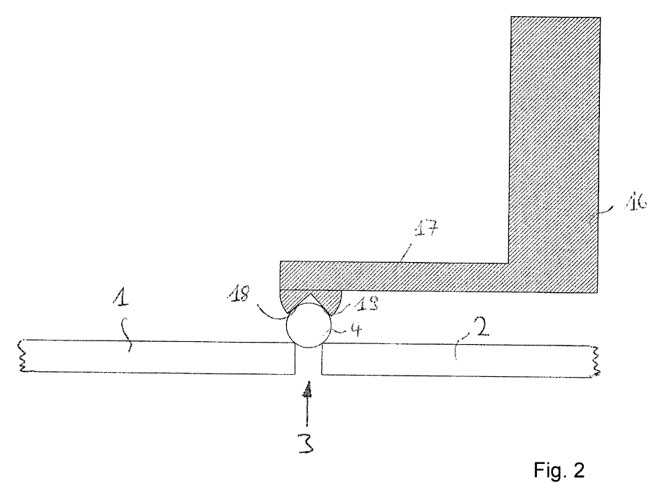

In FIG. 2, the holding-down device is illustrated.

Individual technical features of the embodiments explained in the following can be combined also in combination with aforementioned embodiments as well as the features of possible further claims to subject matter in accordance with the invention.

Inasmuch as this is meaningful, elements that are functionally acting in the same way are provided with identical reference characters.

According to FIG. 1 a) two starting sheets 1, 2 of a width of, for example, 60 cm in the direction B are considered. In the longitudinal direction (perpendicular into the plane of the illustration or out of it) the starting sheets are removed from a coil in the desired length, cut, or are supplied as already cut-to-length sheet metal plates and subsequently are positioned adjacent to each other with a gap 3 spacing them apart from each other. A welding wire 4 is wider than the gap 3 and is placed from above onto the gap. With the bottom sides 6 and 7 the starting sheets 1 and 2 are resting on a worktable, not illustrated, and are secured, for example, magnetically or by vacuum.

The welding wire 4 is subsequently attached in longitudinal direction, i.e., out of the plane of the illustration or into it as described above, by a plurality of welding locations to the starting sheets 1 and 2. Alternatively, in case of an automated wire feeding device, at locations that are spaced apart approximately 1 cm from each other welding points are provided for initial fixation of the starting sheets 1, 2. In this way, a change of the gap size caused by the manufacture of the welding seam and/or welding bead can be counteracted. Moreover, as an alternative, fixation by means of welding points can be omitted in case of a sufficiently large, in particular magnetic, holding force of the worktable.

By means of a pulsed laser of a frequency of 5 Hz subsequently the welding wire 4 is fused with the starting sheets 1 and 2 so that a welding beads 8 results which also encompasses prior parts of the starting sheets 1 and 2.

Subsequently, the starting area with regard to its surface is brought into alignment with the top sides 9 and 10 of the starting sheets 1 and 2 (FIG. 1 c)). This is done preferably by milling and/or grinding.

Subsequently, the starting sheets are turned so that now the prior bottom sides 7 and 8 are positioned on top and accordingly the sides 10 and 9 are now facing the worktable. Now the surface 11 of the welding bead 8 within the gap 3 is after-treated or pre-treated so that in particular a more uniform surface 11 results. The latter is subsequently smoother. Moreover, in the transition areas 12 a more uniform transition of the welding bead into the steel of the starting sheets 1 and 2 is ensured (FIG. 1 d)) by the pre-treatment or after-treatment, again by means of a laser beam, because the adjoining areas of the starting sheets can also be partially melted again. In this way, cinder on the surface of the welding bead can also be removed, for example.

Subsequently, an additional welding wire 14 or welding wire section that is also wider than the gap 3 is positioned again so as to be in contact with the corners of the starting sheets 1 and 2 along the gap and is partially positioned therein. An attachment of the wire 14 to the starting sheets 1, 2 with individual welding points can be done as in the first working step. This is however not mandatorily needed as a result of the already present welding bead.

After positioning of the welding wire according to FIG. 1 e), according to FIG. 1 f) an additional welding bead 15 is generated so that the gap now is completely gone.

Subsequently, the surface of the welding bead 15 is brought into alignment with the neighboring surfaces according to FIG. 1 g). Now the steel sheet with a width of approximately 120 cm (with added width of the common weld seams) is finished.

According to FIG. 2, a holding-down device 16 is used in order to secure the welding wire 4 at the gap (3) between the two sheets 1 and 2 to be welded to each other. The wire in this variant is not secured beforehand but can be fed by a feeding device preferably in an automated fashion from a roll, for example. The holding-down device comprises in this context an arm 17 having at its end a holding element 18. By means of a notch 19 provided in the holding element and extending in the longitudinal direction relative to the wire, the wire is secured against the gap.

By means of the method according to the invention, several, for example, three approximately 40 cm wide steel sheet strips can be connected to each other for producing a steel sheet of a width of, for example, 1.20 m. Also, even wider steel sheets can be produced.

In a further embodiment of the method, in particular in case of steel sheets with a thickness above 1 mm, more than two welding beads by use of more than two welding wires or welding wire sections are produced wherein the welding beads which are positioned in the interior of the weld seam is preferably generated by use of a welding wire with a diameter that is smaller than the average width of the gap. The use of additional welding wires for generating additional welding beads makes it possible to fill the gap volume between the steel sheets completely with reliable processing and to generate in this way a strong connection of the steel sheets.

The minimal weld distortion and the minimal after-processing expenditure resulting therefrom enable in an alternative embodiment of the method the immediate production of flexible dies by use of the afore described welding method. For this purpose, steel sheets that are already provided by etching or engraving with the final die cutting pattern and are suitable for die cutting are welded to each other. Accordingly, the die cutting lines can be pre-manufactured on smaller surfaces and thus on smaller devices in a flexible way.

What is claimed is:

1. Method for manufacturing steel sheets for flexible dies with a width of at least 70 cm and a length of at least 30 cm, characterized by positioning at least two starting sheets (1, 2) adjacent to each other and spaced apart by a gap (3), arranging a welding wire (4) at the gap, in particular in contact with both starting sheets (1, 2), preferably in longitudinal direction of the gap (3) and preferably at least partially within the gap (3), welding the two starting sheets (1, 2) to each other by means of the welding wire (4, 14) and a welding device arranged in particular above a first side of the starting sheets (1, 2), in particular turning the starting sheets (1, 2) connected to each other, arranging an additional welding wire (14), preferably in longitudinal direction of the gap (3) and in particular at least partially within the gap (3) as well as in particular in contact with both starting sheets (1, 2), welding the starting sheets (1, 2) to each other by means of the additional welding wire (14) and bringing into alignment at least one of the welding beads (8, 15) with neighboring surfaces of the steel sheet.

2. Method according to claim 1, characterized in that bringing into alignment the welding beads (8, 15) with the surfaces is realized immediately after welding in such a way that the welding beads (8, 15) exhibit a temperature above the ambient temperature.

3. Method according to claim 1, wherein for fixation of the starting sheets (1, 2) and for forming a uniform gap (3) the starting sheets (1, 2) by the welding device and the welding wire (4, 14) are connected to each other by a plurality of spaced-apart welding locations and/or the welding wire is fed automatically during the welding process.

4. Method according to claim 1, wherein, after manufacture of a first welding bead (8), its welding bead surface (11) positioned within the gap (3) is pre-treated.

5. Method according to claim 4, characterized in that the welding bead surface (11) is heated.

6. Method according to claim 1, wherein the welding device comprises a laser which can be operated in particular in pulsed operation.

7. Method according to claim 6, characterized in that the laser for manufacturing the weld seam is operated at a frequency between 1 and 20 Hz, in particular between 3 and 7 Hz.

8. Method according to claim 6, wherein the laser beam in the area in which it is impinging on one of the welding wires (4, 14) has a diameter that is maximally 0.5 mm smaller than the width of the welding wire.

9. Method according to claim 1, wherein the diameter of at least one of the welding wires (4, 14) is greater than the width of the gap (3).

10. Method according to claim 1, wherein at least a third welding wire is introduced into the gap.

11. Method according to claim 1, wherein the gap (3) between the starting sheets (1, 2) has a width of not more than 2 mm.

12. Method according to claim 1, wherein the gap (3) is above a cooling channel of a worktable.

13. Method according to claim 1, wherein the welding beads (8, 15) each are formed by welding points that are passing into each other whose centers are spaced from each other by about 0.5 mm±0.2 mm.

14. Method according to claim 1, wherein for fixation and cooling of the starting sheets a holding device secures the starting sheets.

15. Flexible die of a width of at least 70 cm and a length of at least 30 cm, characterized in that the flexible die is formed of at least two starting sheets of steel, in particular of C60 steel, that are welded to each other.

16. Flexible die produced by a method according to claim 1.

17. Flexible die according to claim 16, wherein the starting sheets are provided with die cutting lines already prior to welding.

18. Flexible die according to claim 15, wherein the starting sheets are provided with die cutting lines prior to welding.
